(19) United States
(12) Patent Application Publication
(10) Pub. No.: US 2017/0374222 A1
(43) Pub. Date: Dec. 28, 2017

(54) IMAGE READING METHOD AND IMAGE READING APPARATUS

(71) Applicant: CANON KABUSHIKI KAISHA, Tokyo (JP)

(72) Inventor: Tadao Hayashide, Utsunomiya-shi (JP)

(21) Appl. No.: 15/623,843

(22) Filed: Jun. 15, 2017

(30) Foreign Application Priority Data
Jun. 27, 2016 (JP) 2016-126796

(51) Int. Cl. H04N 1/028; H04N 1/00; H04N 1/10

(52) U.S. Cl. CPC H04N 1/0281; H04N 1/10; H04N 1/00816; H04N 2201/0081

(57) ABSTRACT

An image reading method in the present invention includes: obtaining a pickup image by performing image pickup of an object mounted on a mounting surface with an imaging unit; and extracting an image of the object from the pickup image, based on a brightness difference between the image of the object and an image of a shadow of the object in the pickup image.

### BACKGROUND OF THE INVENTION

### Field of the Invention

The present invention relates to an image reading method and an image reading apparatus.

### Description of the Related Art

An image reading apparatus which can read an image of an object mounted on a mounting table by picking up an image of the object from above has been conventionally known.

Japanese Patent Application Laid-Open No. 2007-67966 discloses an image reading apparatus for recognizing an exact region of an original. The image reading apparatus includes a display panel as an original mounting surface, and is capable of displaying a sheet marker on the display panel according to various inputted conditions such as the size of the original whose image is to be picked up, and reading an image of the original after the user sets the original within an area indicated by the sheet marker.

However, the image reading apparatus disclosed in Japanese Patent Application Laid-Open No. 2007-67966 has difficulty in reading the exact image of the original because there is a limit to how accurate the user can set the original according to the sheet marker. Moreover, the image reading apparatus forces the user to perform cumbersome work of setting the original according to the sheet marker.

### SUMMARY OF THE INVENTION

In view of this, an object of the present invention is to provide an image reading method and an image reading apparatus which enables accurate and easy reading of an image of an object mounted on a mounting surface.

The present invention includes obtaining a pickup image by performing image pickup of an object mounted on a mounting surface with an imaging unit; and extracting an image of the object from the pickup image, based on a brightness difference between the image of the object and an image of a shadow of the object in the pickup image.

Further features of the present invention will become apparent from the following description of exemplary embodiments with reference to the attached drawings.

### BRIEF DESCRIPTION OF THE DRAWINGS

FIG. 1A is a schematic perspective view of an image reading apparatus according to a first embodiment.

FIG. 1B is a schematic xy cross-sectional view of the image reading apparatus according to the first embodiment.

FIG. 1C is a schematic yz cross-sectional view of the image reading apparatus according to the first embodiment.

FIG. 2A is a view illustrating how a shadow portion of an original is appropriately formed in the image reading apparatus according to the first embodiment.

FIG. 2B is a view illustrating how the shadow portion of the original is appropriately formed in the image reading apparatus according to the first embodiment.

FIG. 2C is a view illustrating how the shadow portion of the original is appropriately formed in the image reading apparatus according to the first embodiment.

FIG. 3A is a view illustrating an example of an image reading operation of the image reading apparatus according to the first embodiment.

FIG. 3B is a view illustrating an example of the image reading operation of the image reading apparatus according to the first embodiment.

FIG. 3C is a view illustrating an example of the image reading operation of the image reading apparatus according to the first embodiment.

FIG. 4 is a flowchart of an operation of the image reading apparatus in an image reading method of the first embodiment.

FIG. 5A is a schematic perspective view of an image reading apparatus according to a second embodiment.

FIG. 5B is a schematic xy cross-sectional view of the image reading apparatus according to the second embodiment.

FIG. 5C is a schematic yz cross-sectional view of the image reading apparatus according to the second embodiment.

### DESCRIPTION OF THE EMBODIMENTS

Preferred embodiments of an image reading method and an image reading apparatus in the present invention will now be described in detail in accordance with the accompanying drawings.

Note that, in the drawings described below, objects may be illustrated in scales different from the actual ones to facilitate the understandings of the present invention.

### First Embodiment

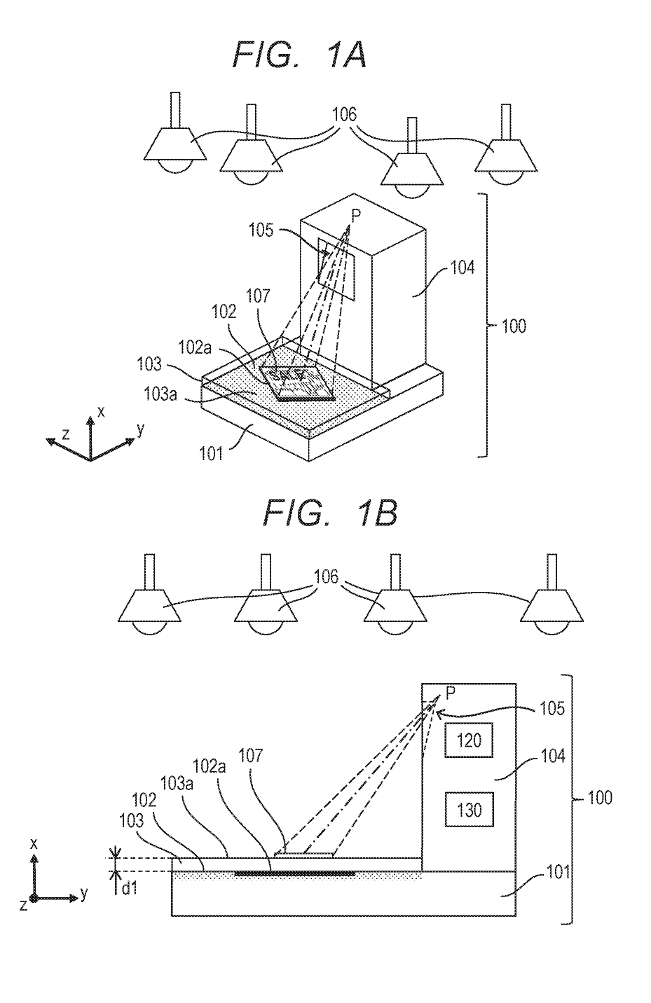

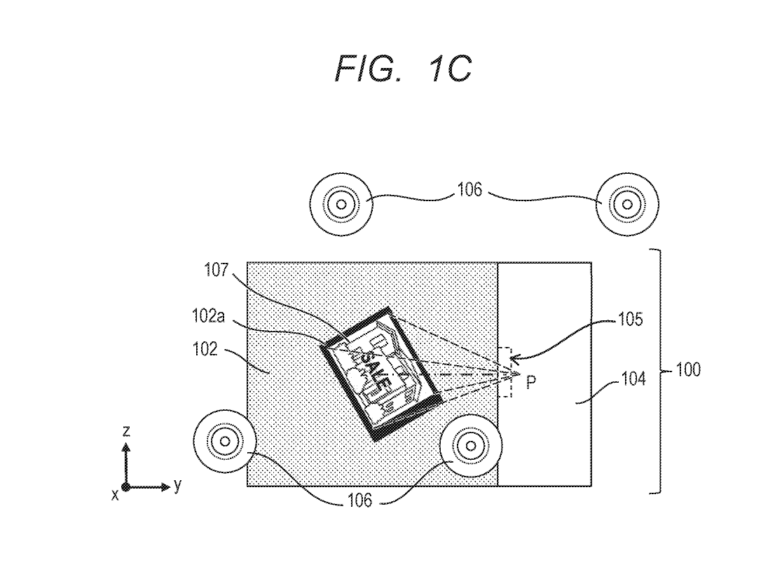

FIGS. 1A, 1B, and 1C are respectively a schematic perspective view, a schematic xy cross-sectional view, and a schematic yz cross-sectional view of an image reading apparatus 100 in a first embodiment.

Note that, in this description, an x-axis is defined as a direction perpendicular to a mounting surface 103a of the image reading apparatus 100, and a y-axis and a z-axis are defined as directions orthogonal to each other in a plane including the mounting surface 103a.

The image reading apparatus 100 includes a mounting table 101, a screen surface (projection surface, white member) 102, a transparent plate (light transmitting member) 103, a main body 104, an imaging unit 105, an image processing unit (processing unit) 120, and a control unit 130.

As illustrated in FIGS. 1A to 1C, the screen surface 102 and the main body 104 are provided on the mounting table 101.

Moreover, the transparent plate 103 is disposed on the screen surface 102, and an original 107 is mounted on the mounting surface 103a of the transparent plate 103. Accordingly, the screen surface 102 and the mounting surface 103a are parallel to each other and are spaced away from each other in the x-axis direction.

In the main body 104, there are provided: the imaging unit 105 including a not-illustrated lens element and a not-illustrated area imaging element (imaging element); the image processing unit 120; and the control unit 130. In the imaging unit 105, the lens element focuses light reflected from the original 107 onto the area imaging element. The imaging unit 105 thereby performs image pickup to obtain an image including the original 107.

Note that the imaging unit 105 is disposed at such a position that the imaging unit 105 can pick up the image of the mounting surface 103a from an oblique upper side thereof. In other words, the center position of the area imaging element of the imaging unit 105 is off the normal to the original 107.

As illustrated in FIGS. 1A to 1C, in the image reading apparatus 100, when the original 107 is mounted on the mounting surface 103a, a shadow portion 102a is formed on the screen surface 102 by illuminating the original 107 by an illuminating apparatus 106 provided outside the image reading apparatus 100.

In the image reading apparatus 100 in the embodiment, at least parts of at least one of short sides and at least one of long sides of the original 107 can be clearly detected by using this shadow portion 102a.

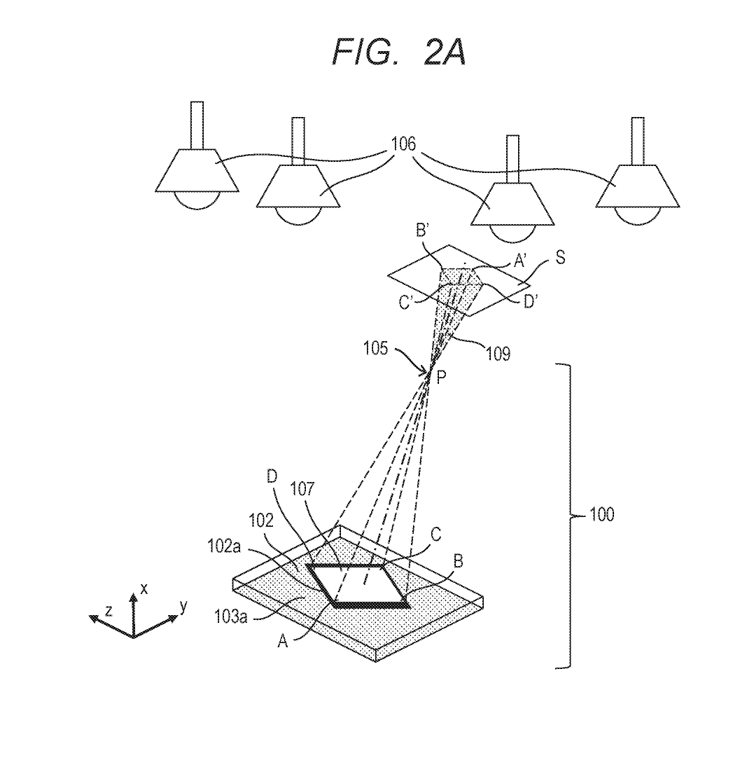

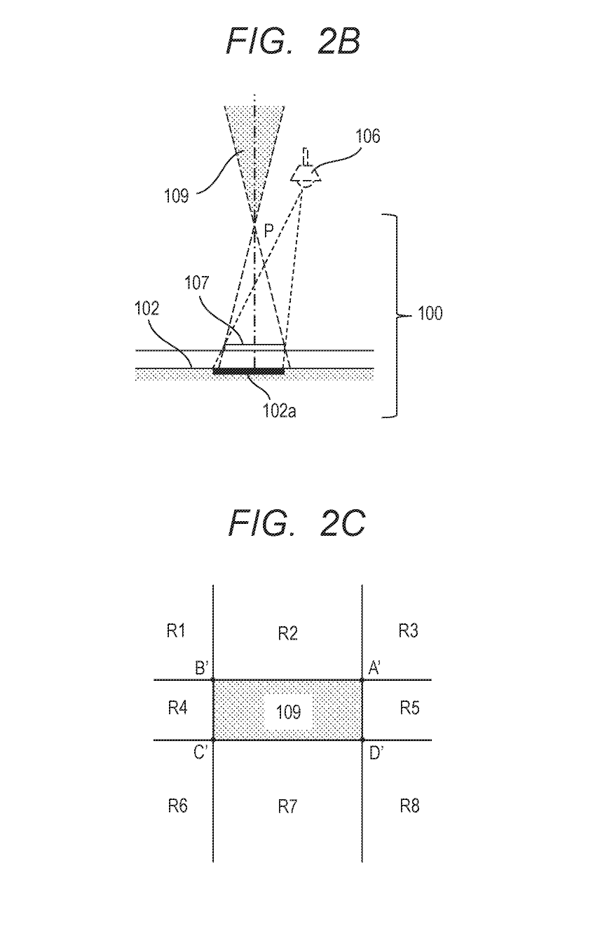

FIGS. 2A, 2B, and 2C illustrate how the shadow portion 102a is appropriately generated to clearly detect at least the parts of at least one short side and at least one long side of the original 107 in the image reading apparatus 100 in the embodiment.

In this embodiment, the original 107 is assumed to be a rectangular original with a size such as A4 or B4 (predetermined rectangular size) defined in a general standard, and vertices of the original 107 are referred to as vertex A (first vertex), vertex B (second vertex), vertex C (third vertex), and vertex D (fourth vertex).

As illustrated in FIG. 2A, the imaging unit 105 is assumed to be disposed such that the center of the area imaging element is at the position of the point P (first position). Then, a first plane denotes a plane including a segment PA (first segment) and a segment PB (second segment), a second plane denotes a plane including the segment PB and a segment PC (third segment), a third plane denotes a plane including the segment PC and a segment PD (fourth segment), and a fourth plane denotes a plane including the segment PD and the segment PA.

Provided that regions which are on the opposite sides of the first, second, third, and fourth planes to the original 107 (hereafter, also referred to as original 107 opposite side) are first, second, third, and fourth regions, a region where the first to fourth regions overlap is defined as a region 109.

In other words, the region 109 can be considered as a pyramid whose apex is the point P and whose base is at infinity on the upper side.

FIG. 2C illustrates a cross-sectional view obtained by cutting the region 109 along a certain plane S which is parallel to the mounting surface 103a and which is farther away from the mounting surface 103a than the point P is. Note that, in FIG. 2C, the point P where the imaging unit 105 is disposed is assumed to be directly above the center of the rectangular original 107 in the x-axis direction for simplification, and intersections where extended lines of the segments PA, PB, PC, and PD intersect the plane S are referred to as A′, B′, C′, and D′, respectively. Moreover, regions around the region 109 on the plane S (that is, regions outside the pyramid 109) are referred to as R1, R2, . . . , and R8.

First, when one illuminating apparatus 106 is disposed in the region R2 which is at the original 107 side of the first plane and which is at the original 107 opposite side of the second and fourth planes, the shadow portion 102a is formed on the screen surface 102, outside the long side AB of the original 107, such that the imaging unit 105 can pick up the image of the shadow portion 102a. However, no shadow portion 102a is formed on the screen surface 102, outside the other sides BC, CD, and DA (at such positions that the imaging unit 105 can pick up the image of the shadow portion 102a).

Similarly, when one illuminating apparatus 106 is disposed in the regions R4, R5, or R7 which is at the original 107 side of the second, third, or fourth plane and which is at the original 107 opposite side of the other planes, the shadow portion 102a is formed on the screen surface 102, outside one of the sides of the original 107, such that the imaging unit 105 can pick up the image of the shadow portion 102a. However, no shadow portion 102a is formed on the screen surface 102, outside the other sides (at such positions that the imaging unit 105 can pick up the image of the shadow portion 102a).

Accordingly, in order to form the shadow portion 102a on the screen surface 102 outside at least the parts of at least one short side and at least one long side of the original 107 such that the imaging unit 105 can pick up the image of the shadow portion 102a by using one illuminating apparatus 106, the illuminating apparatus 106 may be disposed in the regions R1, R3, R6 or R8 out of the regions R1 to R8.

Specifically, one illuminating apparatus 106 may be disposed in any of the region R1 which is at the original 107 side of the first and second planes and which is at the original 107 opposite side of the third and fourth planes, the region R3 which is at the original 107 side of the first and fourth planes and which is at the original 107 opposite side of the second and third planes, the region R6 which is at the original 107 side of the second and third planes and which is at the original 107 opposite side of the first and fourth planes, and the region R8 which is at the original 107 side of the third and fourth planes and which is at the original 107 opposite side of the first and second planes.

Note that it is described outside “at least the parts of” the short side and the long side due to the following reason. When the original is illuminated from the regions R1, R3, R6, or R8, an image of a boundary between the imagable shadow portion 102a and the side of the original along which the imagable shadow portion 102a is formed cannot be picked up over the entire length of this side (each of the long side and the short side) because the height of the mounting surface 103a and the height of the screen surface 102 are different.

Meanwhile, when there are two or more illuminating apparatuses 106, one of the illuminating apparatuses 106 is disposed in the region R1, R2, R3, R6, R7, or R8 which is at the original 107 side of the first plane including the long side AB of the original 107 or the third plane including the long side CD of the original 107. Then, another one of the illuminating apparatuses 106 is disposed in the region R1, R3, R4, R5, R6, or R8 which is at the original 107 side of the second plane including the short side BC of the original 107 or the fourth plane including the short side DA of the original 107. The shadow portion 102a can be thereby formed on the screen surface 102, outside at least the parts of at least one short side and at least one long side of the original 107, such that the imaging unit 105 can be image the shadow portion 102a.

Meanwhile, when the illuminating apparatuses 106 are disposed inside the region 109, that is at the original 107 opposite side of all of the first to fourth planes, no shadow portion 102a is formed on the screen surface 102, outside any of the four sides of the original 107, such that the imaging unit 105 can pick up the image of the shadow portion 102a.

The region which includes the point P where the imaging unit 105 is disposed and which is above, in the x-axis direction, a fifth plane parallel to the mounting surface 103a is described above.

In a portion below the fifth plane in the x-axis direction, by disposing the illuminating apparatus 106 at any position in a fifth region between the fifth plane and a sixth plane including the mounting surface 103a, the shadow portion 102a can be formed on the screen surface 102, outside at least the parts of at least one short side and at least one long side of the original 107, such that the imaging unit 105 can pick up the image of the shadow portion 102a.

As described above, in the image reading method in the embodiment, the shadow portion 102a can be formed on the screen surface 102, outside at least the parts of at least one short side and at least one long side of the original 107, such that the imaging unit 105 can pick up the image of the shadow portion 102a, by disposing at least one portion of at least one illuminating apparatus 106 in the region (hereafter, referred to as detectable region) at the original 107 side of at least two of the first, second, third, and fourth planes, the two planes respectively including adjoining two sides (specifically, the short side and the long side) of the original 107.

The image processing unit 120 processes a pickup image obtained by performing image pickup in this state, and can thereby detect at least the parts of at least one short side and at least one long side of the original 107, from the brightness difference between the original 107 and the shadow portion 102a.

Note that any point in the fifth region is in the detectable region.

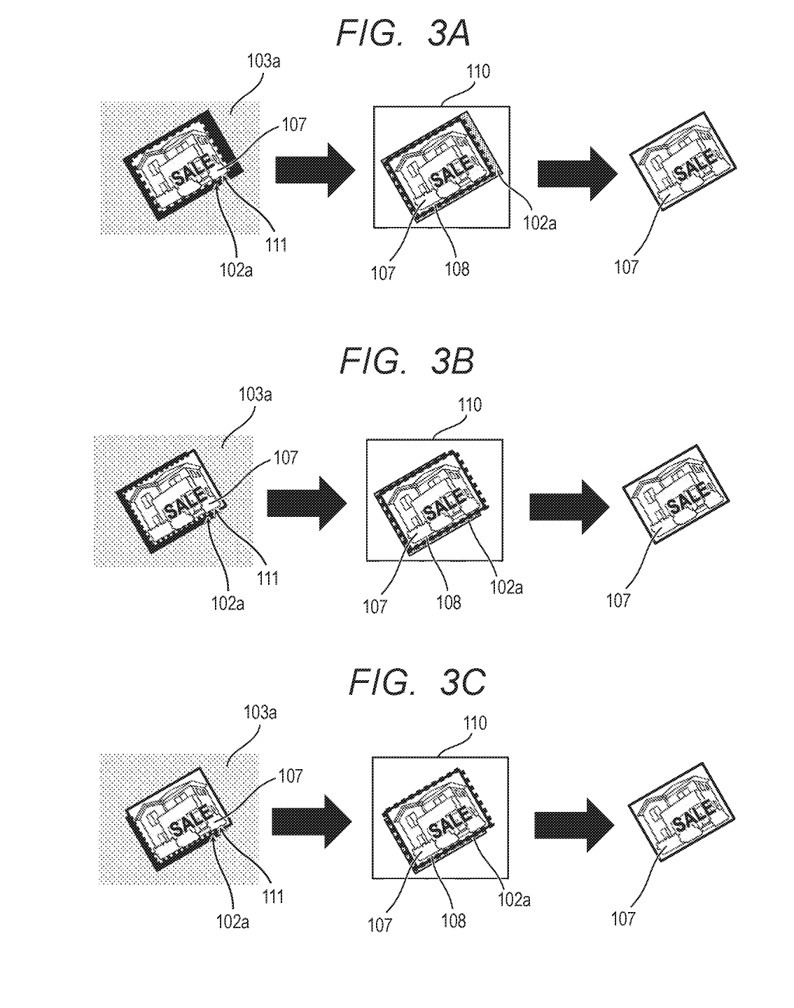

Then, the image processing unit 120 selects a standard size with a length closest to the length of at least the parts of at least one short side and at least one long side of the detected original 107, from size information on predetermined standards stored in a not-illustrated storage unit. The size, position, and orientation of the original 107 (rectangular boundary 108 in FIGS. 3A to 3C) are thereby determined (obtained).

Then, the image processing unit 120 can read the image of the original 107 by cropping (performing extraction on) the image information obtained in the image pickup by the imaging unit 105, based on the determined size, position, and orientation of the original 107.

FIGS. 3A, 3B, and 3C illustrate examples of the aforementioned image reading operation of the image reading apparatus 100 in the embodiment.

Note that FIG. 3A illustrates the case where the shadow portion 102a is formed on the screen surface 102, outside all of the four sides of the original 107, such that the imaging unit 105 can pick up the image of the shadow portion 102a. FIG. 3B illustrates the case where the shadow portion 102a is formed on the screen surface 102, outside two long sides and one short side of the original 107, such that the imaging unit 105 can pick up the image of the shadow portion 102a. FIG. 3C illustrates the case where the shadow portion 102a is formed on the screen surface 102, outside one long side and one short side of the original 107, such that the imaging unit 105 can pick up the image of the shadow portion 102a.

First, when the illuminating apparatus 106 illuminates the original 107, the shadow portion 102a is formed on the screen surface 102, outside, for example, all four sides of the original 107.

Then, the imaging unit 105 obtains an image 110 by performing image pickup of the original 107 and the shadow portion 102a.

Next, the image processing unit 120 processes the obtained image 110 to detect a boundary 111 between the original 107 and the shadow portion 102a from the brightness difference therebetween. Then, the obtained boundary 111 is compared with standard sizes to determine the rectangular boundary 108 corresponding to the size, position, and orientation of the original 107.

Next, the image 110 is cropped based on the rectangular boundary 108 and the image of the original 107 can be thus read.

Moreover, as long as the conditions described above are satisfied, at least the parts of at least one short side and at least one long side of the original 107 can be detected not only indoors but also outdoors, by using, for example, sunlight.

Furthermore, at least the parts of at least one short side and at least one long side of the original 107 can be detected also in a room provided with the illuminating apparatus 106 so large as to cover the inside and outside of the detectable region.

Moreover, as long as the conditions described above are satisfied, at least the parts of at least one short side and at least one long side of the original 107 can be detected also in a room using indirect illuminating in which a light diffusing plate or a reflection plate is disposed on a ceiling and light is incident on the light diffusing plate or the reflection plate.

Furthermore, as long as the conditions described above are satisfied, at least the parts of at least one short side and at least one long side of the original 107 can be detected also outdoors under a cloudy sky.

Note that, although the object whose image is to be picked up is considered to be the rectangular original in the embodiment, the object is not limited to this and may be a three-dimensional object with a certain thickness as long as it has a rectangular shape and a size based on a certain standard. In other words, the object may be a three-dimensional object whose cross section parallel to the mounting surface 103a is a rectangle.

In summary, in the image reading method in the embodiment, the four planes are defined for the respective sides of the original 107 as the planes including the sides of the original 107 and the position of the imaging unit 105. The positional relationships among an illumination light source, the original 107, and the imaging unit 105 are set such that at least one illumination light source is at least partially located in the region on the original 107 side of at least two of the four planes, the two planes respectively including two adjoining sides of the original 107. Then, image pickup of the original 107 is performed and the image of the original 107 can be read from the obtained image.

The illumination light source herein includes illuminating apparatuses such as a fluorescent lamp and a LED, the sun, a light diffusing plate, a reflection plate, a cloudy sky, and the like.

Next, the darkness and size of the formed shadow portion 102a are discussed.

The distance between the mounting surface 103a and the screen surface 102 in the vertical direction, that is the thickness of the transparent plate 103 is denoted by d1.

In this case, the size and darkness of the shadow portion 102a greatly depends on d1 and secondly depends on the distance between the illuminating apparatus 106 and the mounting surface 103a.

Specifically, when d1 is small, the shadow portion 102a is dark but the area of the shadow portion 102a is small. Accordingly, depending on the imaging resolution of the imaging unit 105, the boundary 111 of the original 107 is difficult to detect. Hereafter, such a state of the shadow portion 102a is referred to as dark-small state.

Meanwhile, when d1 is large, the area of the shadow portion 102a is large but the shadow portion 102a is light. Accordingly, the brightness difference between the original 107 and the shadow portion 102a in the boundary 111 of the original 107 is insufficient and the detection of the boundary 111 of the original 107 is difficult also in this case. Hereafter, such a state of the shadow portion 102a is referred to as light-large state.

The image reading apparatus 100 in the embodiment satisfies the following conditional expression (1):

60<d1×K<3000 (1)

where K is the imaging resolution of the imaging unit 105 in dots per inch (dpi). Note that the unit of d1 is mm in this expression.

The image reading apparatus 100 in the embodiment can generate the shadow portion 102a having appropriate darkness and area by satisfying the aforementioned conditional expression (1).

Note that the image reading apparatus 100 in the embodiment more preferably satisfies the following conditional expression (1a):

150<d1×K<1800 (1a).

In the image reading apparatus 100 in the embodiment, d1 is 1 mm and K is 300 dpi. Accordingly, d1×K=300, and not only the expression (1) but also the expression (1a) is satisfied.

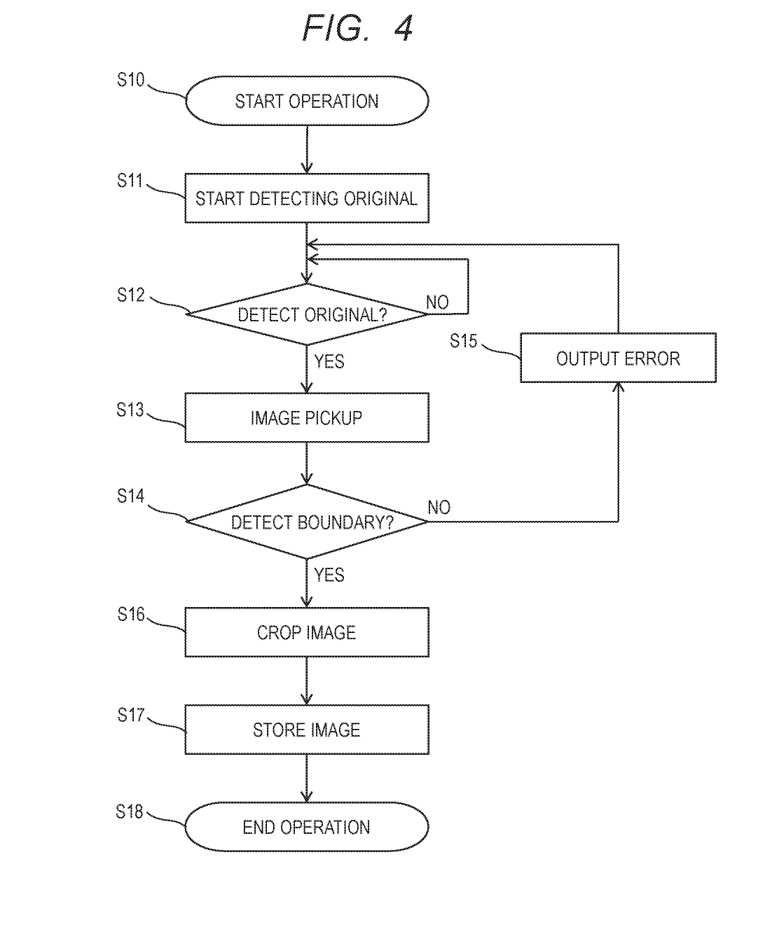

FIG. 4 illustrates a flowchart of an operation of the image reading apparatus 100 in the image reading method of the embodiment.

First, when the image reading apparatus 100 starts the operation (S10), the control unit 130 starts to detect whether the original 107 is mounted on the mounting surface 103a (S11).

When the control unit 130 detects that the original 107 is mounted on the mounting surface 103a (Yes in S12), the imaging unit 105 performs the image pickup (S13).

Next, the image processing unit 120 performs image processing on the image 110 obtained by the image pickup and determines the position of the rectangular boundary 108 of the original 107 in the picked-up image 110 by comparing the result of the image processing with numerical values of predetermined standards (S14).

When the image processing unit 120 cannot determine the rectangular boundary 108 of the original 107 (No in S14), an error message such as “please rearrange the original” is outputted (S15) and the processing returns to S11.

When the image processing unit 120 determines the rectangular boundary 108 of the original 107 (Yes in S14), the image processing unit 120 crops an image from the image 110 (S16). Then, the cropped image corresponding to the original 107 is stored in a not-illustrated storage device (S17) and the operation of the image reading apparatus 100 is ended (S18).

The image processing unit 120 performs processing on the picked-up image and sends the image to the not-illustrated storage device such as an SD card. Moreover, the image reading apparatus can be used as a photocopier or an image scanner by sending the image to a printer, a personal computer, or the like.

### Second Embodiment

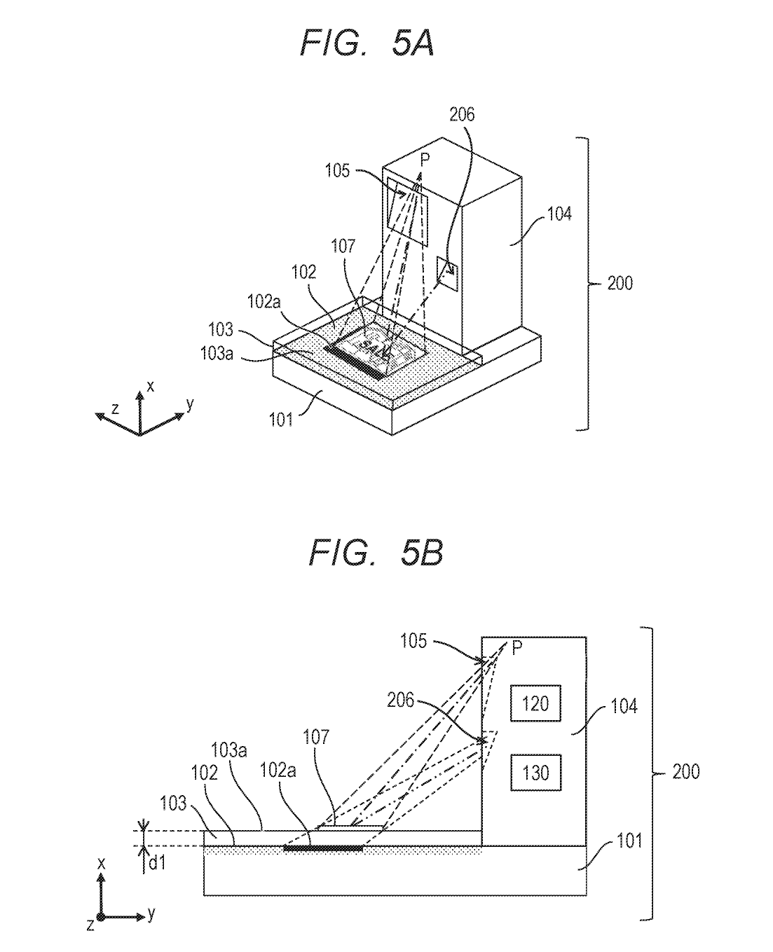

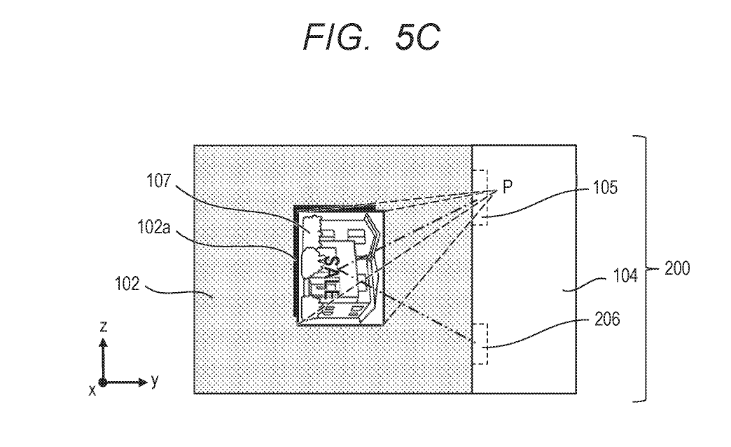

FIGS. 5A, 5B, and 5C are respectively a schematic perspective view, a schematic xy cross-sectional view, and a schematic yz cross-sectional view of an image reading apparatus 200 in a second embodiment.

Note that the image reading apparatus 200 in the second embodiment has the same configuration as the image reading apparatus 100 in the first embodiment except for the point that the image reading apparatus 200 newly includes a projector unit (illuminating unit, projection unit) 206. Accordingly, the same parts are denoted by the same reference numerals and description thereof is omitted.

As illustrated in FIGS. 5A to 5C, in the image reading apparatus 200 in the embodiment, the projector 206 is provided in the main body 104 and includes a light source apparatus, an image display element, and a lens element which are not illustrated.

In the projector 206, a light flux emitted from the light source apparatus passes through the image display element and is then guided by the lens element such that an image is projected on the mounting surface 103a of the transparent plate 103.

Note that the projector 206 is disposed at such a position that the projector 206 projects the image on the mounting surface 103a from the oblique upper side thereof.

The projector 206 can be used for various applications such as projecting, on the mounting surface 103a, an image to guide a user on how to operate the image reading apparatus 200 and displaying, on the mounting surface 103a, a preview of an image picked up by the imaging unit 105.

Moreover, the projector 206 can illuminate on the original 107 by projecting a white image (white light) on the mounting surface 103a and form the shadow portion 102a on the screen surface 102 as in the first embodiment.

In the image reading apparatus 200 in the embodiment, the projector 206 is provided in the main body 104 to be located in the fifth region between the fifth plane and the sixth plane, the fifth plane including the point P where the center of the area imaging element of the imaging unit 105 is located and being parallel to the mounting surface 103a, the sixth plane including the mounting surface 103a.

This allows the projector 206 to form the shadow portion 102a on the screen surface 102, outside at least the parts of at least one short side and at least one long side of the original 107, such that the imaging unit 105 can pick up the image of the shadow portion 102a.

This is because the position of the projector 206 is at the original 107 side of the fifth plane and is thus inevitably on the original 107 side of two of the four planes which include the point P (position where the imaging unit is disposed) and which respectively include the sides of the original on the mounting surface 103a, the two planes respectively including two adjoining sides of the original 107.

Then, the image processing unit 120 performs image processing on the image obtained in the image pickup performed in this state and can thereby detect at least the parts of at least one short side and at least one long side of the original 107, from the brightness difference between the original 107 and the shadow portion 102a.

Then, the image processing unit 120 selects a standard size with a length closest to the length of at least the parts of at least one short side and at least one long side of the detected original 107, from the sizes of sheets in predetermined standards stored in a not-illustrated storage unit to determine the size, position, and orientation (rectangular boundary 108 in FIGS. 3A to 3C) of the original 107.

Then, the image processing unit 120 crops an image from the image obtained in the image pickup by the imaging unit 105, based on the determined size, position, and orientation of the original 107, and can thereby read the image of the original 107.

Note that an example of the aforementioned image reading operation of the image reading apparatus 200 in the embodiment is as illustrated in FIGS. 3A to 3C like the first embodiment.

Moreover, although the object whose image is to be picked up is considered to be the rectangular original in the embodiment, the object is not limited to this and may be a three-dimensional object with a certain thickness as long as it has a rectangular shape and a size based on a certain standard. In other words, the object may be a three-dimensional object whose cross section parallel to the mounting surface 103a is a rectangle.

Next, the darkness and size of the formed shadow portion 102a are discussed. In the image reading apparatus 200 in the embodiment, d1 is 2 mm and K is 400 dpi. Accordingly, d1×K=800, and not only the expression (1) but also the expression (1a) is satisfied.

Hence, in the image reading apparatus 200 in the embodiment, it is possible to generate the shadow portion 102a having appropriate darkness and area.

Moreover, a flowchart of the operation of the image reading apparatus 200 in the image reading method of the embodiment is as illustrated in FIG. 4 like the first embodiment.

Note that the projector 206 may display states corresponding to the operation flow of the image reading apparatus 200 in the embodiment, as messages on the mounting surface 103a.

The image processing unit 120 performs processing on the picked-up image and sends the image to the not-illustrated storage device such as an SD card. In this case, the projector 206 may display a preview of the picked-up image on the mounting surface 103a to allow the user to check the image.

Moreover, the image reading apparatus can be used as a photocopier or an image scanner by sending the picked-up image to a printer, a personal computer, or the like.

The image reading apparatus 200 in the embodiment has the following characteristic. The intensity of illumination light emitted from the projector 206 is constant, differently from in the image reading apparatus 100 in the first embodiment. This facilitates control of generation of the shadow portion 102a, and simplification of processing in a later stage can be achieved more easily.

Moreover, the shadow portion 102a can be appropriately emphasized by appropriately controlling the intensity of the illumination light emitted from the projector 206.

Furthermore, the illumination light emitted from the projector 206 and the illumination light emitted from the external illuminating apparatus 106 or the like may be used together.

Note that the surface of the transparent plate 103 generally has a reflectivity of about 10%. Accordingly, in the image reading apparatuses 100 and 200 in the first and second embodiments, the illumination light emitted from the illuminating apparatus 106 and/or the projector 206 is not only diffusely reflected by the original 107 and the screen surface 102 but also may be totally reflected on the mounting surface 103a and travel toward the user.

Accordingly, the user may be dazzled by the total reflection light and have difficulty in performing the operation. In view of this, anti-reflection processing may be performed, specifically, anti-reflection film may be applied on the mounting surface 103a (that is, on an upper surface of the transparent plate 103) and/or a lower surface of the transparent plate 103.

Note that the anti-reflection film may be applied by using a method such as a method of depositing a dielectric material in a manufacturing process of the transparent plate 103.

Although preferable embodiments of the present invention have been described above, the present invention not limited to these embodiments and various changes and modifications can be made within the scope of the gist of the present invention.

For example, a mesh or the like may be used instead of the transparent plate 103. Moreover, instead of providing the screen surface 102 on the mounting table 101, a transparent plate 103 with a while paint applied on a lower surface may be provided on the mounting table 101. In this case, an upper surface (first surface) of the transparent plate 103 is the mounting surface 103a and the lower surface (second surface) facing the upper surface is the screen surface 102.

The present invention can provide the image reading method and an image reading apparatus which enables accurate and easy reading of an image of an object mounted on the mounting surface.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-126796, filed Jun. 27, 2016, which is hereby incorporated by reference herein in its entirety.

What is claimed is:

1. An image reading method comprising:
obtaining a pickup image by performing image pickup of an object mounted on a mounting surface with an imaging unit; and
extracting an image of the object from the pickup image, based on a brightness difference between the image of the object and an image of a shadow of the object in the pickup image.

2. The image reading method according to claim 1, wherein the shadow of the object is a shadow projected on a projection surface spaced away from the mounting surface.

3. The image reading method according to claim 1, wherein
a cross section of the object parallel to the mounting surface is a rectangle, and
the extracting includes extracting the image of the object from the pickup image, based on at least parts of two adjoining sides of the rectangle detected based on the brightness difference.

4. The image reading method according to claim 1, wherein
a cross section of the object parallel to the mounting surface is a rectangle, and
the obtaining includes illuminating the object from the object side of at least one of four planes each of which includes respective four sides of the rectangle and which include a center position of an imaging element of the imaging unit.

5. The image reading method according to claim 4, wherein the obtaining includes illuminating the object from the object side of two planes each of which includes respective two adjoining sides of the rectangle and which include the center position of the imaging element of the imaging unit.

6. The image reading method according to claim 3, wherein the extracting includes extracting the image of the object from the pickup image, based on a size of the object obtained from at least the parts of the two adjoining sides of the rectangle and rectangle size information stored in advance.

7. The image reading method according to claim 1, wherein the shadow of the object is a shadow projected on a projection surface disposed at an opposite side of the mounting surface to the imaging unit.

8. The image reading method according to claim 3, wherein a center position of an imaging element of the imaging unit is off a normal to the rectangle.

9. An image reading apparatus comprising:
an imaging unit configured to obtain a pickup image by performing image pickup of an object mounted on a mounting surface, and
a processing unit configured to extract an image of the object from the pickup image, based on a brightness difference between the image of the object and an image of a shadow of the object in the pickup image.

10. The image reading apparatus according to claim 9, wherein
a cross section of the object parallel to the mounting surface is a rectangle, and
the processing unit extracts the image of the object from the pickup image, based on at least parts of two adjoining sides of the rectangle detected based on the brightness difference.

11. The image reading apparatus according to claim 9, comprising a projection surface disposed at an opposite side of the mounting surface to the imaging unit, wherein
the shadow of the object is a shadow projected on the projection surface.

12. The image reading apparatus according to claim 11, wherein the projection surface is formed of a white member.

13. The image reading apparatus according to claim 11, comprising the mounting surface, wherein
the mounting surface is formed of a light transmitting member disposed on the projection surface.

14. The image reading apparatus according to claim 9, wherein
a cross section of the object parallel to the mounting surface is a rectangle,
the image reading apparatus comprises a illuminating unit configured to illuminate the object, and
the illuminating unit is disposed at the object side of at least one of four planes each of which includes respective four sides of the rectangle and which include a center position of an imaging element of the imaging unit.

15. The image reading apparatus according to claim 14, wherein the illuminating unit is disposed at the object side of two planes each of which includes respective two adjoining sides of the rectangle and which include the center position of the imaging element of the imaging unit.

16. The image reading apparatus according to claim 9, comprising a projection unit configured to be capable of illuminating the object and projecting an image on the mounting surface.

17. The image reading apparatus according to claim 16, wherein the projection unit is disposed between the mounting surface and the imaging unit in a direction perpendicular to the mounting surface.

18. The image reading apparatus according to claim 10, wherein the processing unit extracts the image of the object from the pickup image, based on a size of the object obtained from at least the parts of the two adjoining sides of the rectangle and rectangle size information stored in advance.

19. The image reading apparatus according to claim 10, wherein a center position of an imaging element of the imaging unit is off a normal to the rectangle.
